(19) United States
(12) Patent Application Publication
(10) Pub. No.: US 2013/0306252 A1
(43) Pub. Date: Nov. 21, 2013

(54) COILING DOOR ASSEMBLY HAVING GUIDE MEMBERS WITH NARROW WALL GAP OPENING AND INTERNAL SMOKE OR WEATHER SEAL

(71) Applicants: Andrew LAMBRIDIS, Dix Hills, NY (US); Ashraf GOMAA, Stony Brook, NY (US)

(72) Inventors: Andrew LAMBRIDIS, Dix Hills, NY (US); Ashraf GOMAA, Stony Brook, NY (US)

(73) Assignee: McKeon Rolling Steel Door Co., Inc., Bellport, NY (US)

(21) Appl. No.: 13/472,763

(22) Filed: May 16, 2012

(51) Int. Cl. E06B 9/50; E06B 7/16; E06B 9/34; E06B 9/00

(52) U.S. Cl. 160/133; 160/368.1; 160/271

(57) ABSTRACT

A guide member for a coiling door or curtain assembly, including a rigid, hollow elongate member having a first wall, a second wall opposing the first wall, and a third wall which is perpendicular to the first and second walls. The first, second, and third walls are arranged to form an internal cavity of the elongate member. The internal cavity has an opening running in a direction of a length of the elongate member, along a side of the elongate member opposing the third wall. A seal is positioned in the internal cavity and attached to the second wall. The first and/or second walls have a stepped portion at the opening of the internal cavity which decreases a width of the opening by decreasing a distance between the first and second walls near the opening.

### BACKGROUND OF THE INVENTION

1. Field of the Invention

The disclosed embodiments relate to a coiling door assembly. More specifically, the disclosed embodiments relate to a coiling door assembly including vertical guide members having a narrow wall gap opening and an internal smoke or weather seal.

2. Description of the Related Art

Coiling door systems, e.g., fire and smoke rated door systems, are used on external and internal door openings and in interior corridors of buildings for security, for protection against nature's elements, as well as to help prevent the spread of fire and smoke in the event of a fire condition in a building. These door systems may include coiling door assemblies, such as vertically-coiling steel door assemblies. Coiling fire-resistant curtain assemblies are also used in interior door openings and corridors. Building and fire codes may require the use of such systems in exterior or interior spaces of a certain size to prevent damage caused by nature's elements, such as heavy winds, snow, rain, or against fire and smoke migration.

Such doors and curtains are held in a coiled configuration at the top of the assembly and when the necessity arises, for fire rated assemblies, they are released automatically in a fire condition and allowed to uncoil downward into a closed position. In interior installations, in particular, these door and curtain systems may be installed so that they are not visible when in the coiled configuration. For example, the housing which holds the coiled steel door may be located in the ceiling of an interior corridor.

However, vertical guide members must be provided in the opposing corridor walls or opposing door jamb surfaces in order to guide the door or curtain as it rolls down and to hold it in place once it has been lowered. These vertical guide members must be installed in gaps in the wall surface which are visible when the doors and curtains are in their non-deployed positions, which is most of the time.

Such wall gaps can be aesthetically unappealing, because they result in a discontinuity in the wall surface and reveal the mechanical infrastructure required to hold the door or curtain in place. The aesthetic qualities of these door and curtain systems is of such significance that an architect may select a particular door or curtain system based almost entirely on the aesthetic appeal. Even relatively small changes in the gap width can have a significant effect on the aesthetics of the door installation. Also, larger wall gaps increase the possibility of dirt and/or foreign material entering the vertical guide member, which may interfere with operation of the door or curtain.

### SUMMARY OF THE INVENTION

In one aspect, the present invention is directed to a guide member for a coiling door assembly. The guide member includes a rigid, hollow elongate member having a first wall, a second wall opposing the first wall, and a third wall which is perpendicular to the first and second walls. The first, second, and third walls are arranged to form an internal cavity of the elongate member. The internal cavity has an opening running in a direction of a length of the elongate member, along a side of the elongate member opposing the third wall. The internal cavity and opening are configured to receive a side edge portion of the door. A smoke or weather seal is positioned in the internal cavity and attached to the second wall. The smoke or weather seal is configured to run along the length of the elongate member and to extend into the cavity to contact the side edge portion of the door when the side edge portion of the door is received in the internal cavity. At least one of the first and second walls has a stepped portion at the opening of the internal cavity which decreases a width of the opening by decreasing a distance between the first and second walls near the opening.

In another aspect, the present invention is directed to a coiling door assembly which includes a door formed of pivotally-interlocking horizontal slats; a lift assembly configured to roll the door up into the coiled position; and a pair of guide members as described above.

Embodiments of these aspects of the present invention may include one or more of the following features. The stepped portion at the opening of the internal cavity of the guide member may decrease a distance between outer surfaces of the first and second walls near the opening of the internal cavity to allow the guide member to be installed in a gap of an installation wall that is narrower than a widest portion of the internal cavity. The first and third walls may be formed by an elongate outer angle member and the second wall may be formed by an elongate inner angle member. The outer angle member may have a right angle bend between the first and third walls. The inner and outer angle members may be affixed together at an overlapping common portion parallel to the third wall. The horizontal slats of the door may have a wind lock positioned on at least an end thereof, and the stepped portion may act to prevent the wind lock from passing through the opening of the internal cavity.

In another aspect, the present invention is directed to a guide member for a coiling curtain assembly. The guide member includes a rigid, hollow elongate member having a first wall, a second wall opposing the first wall, and a third wall which is perpendicular to the first and second walls. The first, second, and third walls are arranged to form an internal cavity of the elongate member. The internal cavity has an opening running in a direction of a length of the elongate member along a side of the elongate member opposing the third wall. The internal cavity and opening are configured to receive a side edge portion of the curtain. A smoke or weather seal is positioned in the internal cavity and attached to the second wall. The smoke or weather seal is configured to run along the length of the elongate member and to extend into the cavity to contact the side edge portion of the door when the side edge portion of the curtain is received in the internal cavity. The first and second walls each have a stepped portion at the opening of the internal cavity which decreases the width of the opening by decreasing a distance between the first and second walls near the opening.

In another aspect, the present invention is directed to a coiling curtain assembly which includes a curtain formed of fire resistant material; a lift assembly configured to roll the curtain up into the coiled position; and a pair of guide members, as described above.

Embodiments of these aspects of the present invention may include one or more of the following features. The stepped portion at the opening of the internal cavity of the guide member may decrease a distance between outer surfaces of the first and second walls near the opening of the internal cavity to allow the guide member to be installed in a gap of an installation wall that is narrower than a widest portion of the internal cavity. The first wall may be formed by a first elongate angle member and the second wall may be formed by an elongate second angle member. The first angle member may have a right angle bend between the first and third walls, and the second angle member may have a right angle bend between the second and third walls. The inner and outer angle members may be affixed together at an overlapping common portion which forms at least a portion of the third wall. The curtain may have stoppers positioned along the side edges thereof, and the stepped portion may act to prevent the stoppers from passing through the opening of the internal cavity.

### BRIEF DESCRIPTION OF THE DRAWINGS

The above and other objects and advantages of the disclosed subject matter will be apparent upon consideration of the following detailed description, taken in conjunction with accompanying drawings, in which like reference characters refer to like parts throughout, and in which:

FIGS. 1A and 1B show an elevation view of a coiling door assembly.

FIG. 2 shows a perspective cut-away view of door with, wind locks, installed in a vertical guide member with an internal smoke or weather seal.

FIG. 3 shows a cross-section view of a door, with wind locks, installed in a vertical guide member with an internal smoke or weather seal.

FIG. 4 shows a cross-section view of a door, without wind locks, installed in a vertical guide member with an internal smoke or weather seal.

FIG. 5 shows a cross-section view of a door, with wind locks, installed in a prior art wide-gap vertical guide member with a stop bar and an external smoke or weather seal.

FIG. 6 shows an elevation view of a coiling fire and smoke rated curtain assembly.

FIG. 7 shows a cross-section view of a curtain installed in a vertical guide member with an internal smoke or weather seal.

FIG. 8 shows a cross-section view of a curtain installed in a prior art wide-gap vertical guide member having an external smoke or weather seal.

### DETAILED DESCRIPTION OF THE PRESENTLY PREFERRED EMBODIMENTS

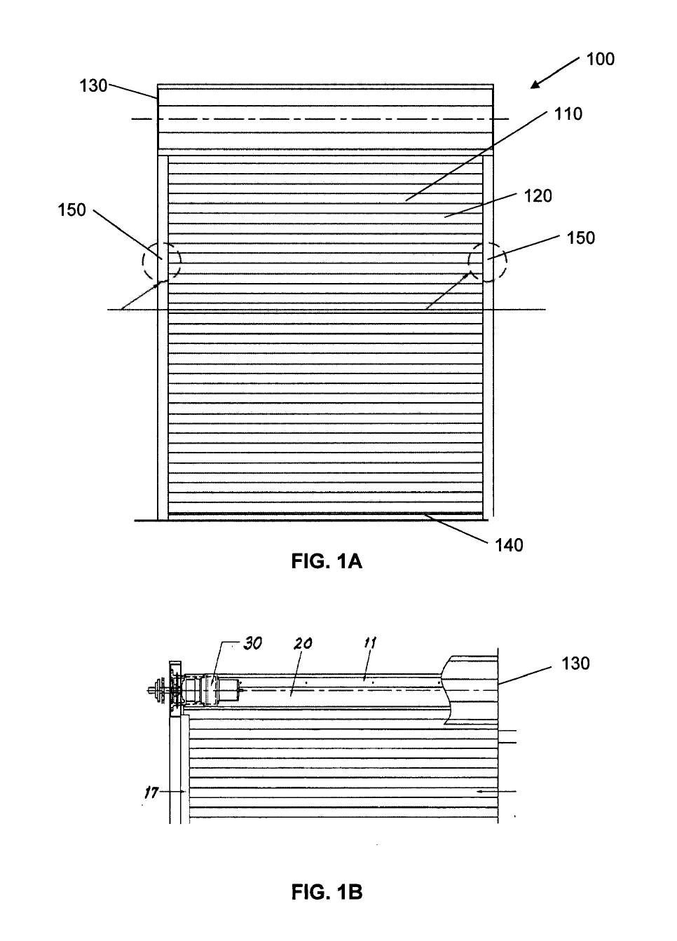

FIG. 1A shows an elevation view of a vertical-coiling door assembly 100, which includes a steel coiling door 110 formed of articulated and interconnected horizontal slats 120. The door assembly 100 may be part of a fire and smoke rated door system.

The articulated slats 120 allow the door 110 to roll up into and down from a coiled configuration inside a housing 130 mounted at the top of the door assembly 100. The slats 120 may be formed of steel, stainless steel, aluminum, or other metals. Each slat 120 may have a curled portion, i.e., a partial cylinder, along the top and bottom edges thereof which can interlock with the corresponding curled portions of adjacent slats, i.e., the slats immediately above and below. Such a configuration allows the slats 120 to pivot relative to one another, which allows the door 110 to roll up into the coiled configuration, as is known in the art.

The door 110 also has a rigid bottom bar 140 which is attached to the bottom-most horizontal slat to ensure a good seal where the bottom of the door meets the floor. The bottom bar 140 may also provide a weight force to pull the door 110 out of the coiled configuration.

The door assembly 100 may be positioned in a door opening, such as an opening in an internal or external wall of a building or an opening spanning a space between two opposed walls which run perpendicular to the plane of the door 110, as in an internal corridor of a building. The door assembly 100 includes a pair of vertical guide members 150 positioned on the sides of the door opening, which hold the door 110 in place and allow the door 110 to move up and down from the coiled configuration.

FIG. 1B is a partial cutaway view of the housing 130, which contains a lift assembly for raising the door 110 into the open, i.e., coiled, position and lowering the door into the closed position. The door 110 has a proximal edge 11 fixed to a drum 20 inside the housing 130. In the closed position, as shown, the door 110 is unwound from drum 20 and extends to cover door opening 17. One or more motors 30 positioned, e.g., on opposite sides of the housing 130 provide the torque necessary to rotate the drum 20 and raise/lower door 110 in/out of the coiled position.

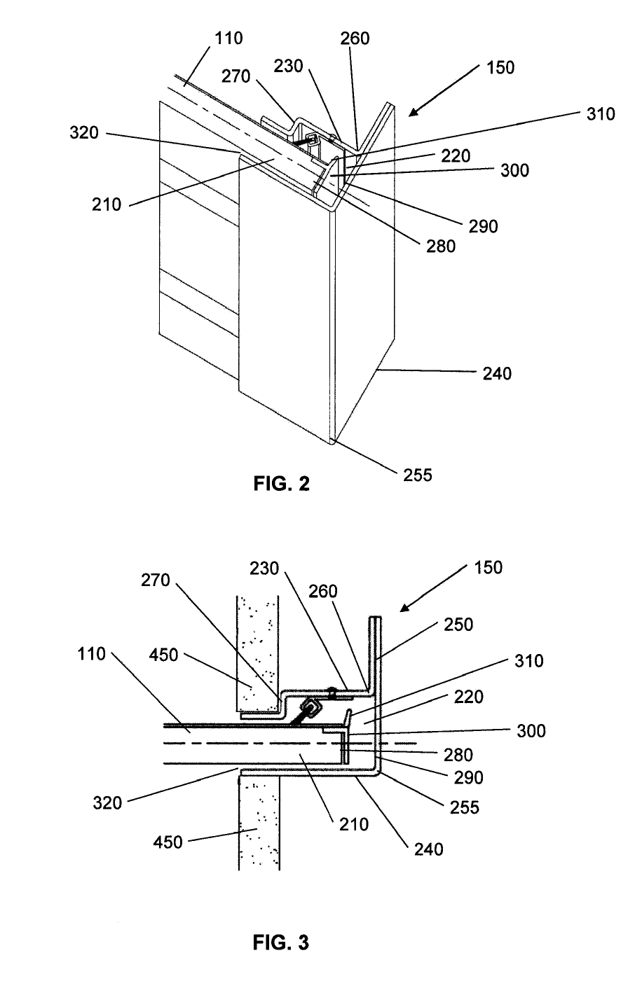

FIGS. 2 and 3 show detailed views of one of the vertical guide members 150. A side edge portion 210 of the door fits within a cavity 220 formed by the guide member 150. In a door assembly, two opposing guide members 150 maintain the horizontal slats 120 of the uncoiled portion of the door in a substantially planar arrangement between the two guide members, i.e., by preventing the slats 120 from pivoting relative to one another. The guide member 150 may be formed of rigid members which are made of metal, e.g., steel, stainless steel, aluminum, or other metals.

The guide member 150 may be formed by an inner guide angle member 230 (“guide angle”) and an outer guide angle member 240 which are joined together in a common portion 250 where faces of the inner guide angle 230 and outer guide angle 240 meet (i.e., faces which are perpendicular to the plane of the door). For example, the guide angles may be bolted or welded together along the common portion 250. This common portion 250 acts as a mounting portion which allows the guide member 150 to be affixed to a wall or a support member.

In the embodiment depicted in FIGS. 2 and 3, the outer guide angle 240 has a single right angle bend 255 and the inner guide angle 230 has a right angle bend 260 and a stepped portion at one end 270 (in certain embodiments, the outer guide angle 240 may have a stepped portion, in addition to or in lieu of the stepped portion 270 of the inner guide angle 230, which may be positioned opposite the stepped portion 270 of the inner guide angle 230). The inner guide angle 230 and outer guide angle 240 are arranged such that the right angle bend 260 of the inner guide angle 230 and the right angle bend 255 of the outer guide angle 240 are aligned in a plane perpendicular to the plane of the door 110. The right angled portions of the inner guide angle 230 and outer guide angle 240 form the front and back sides (see locations indicated by 240 and 230, respectively) of the guide cavity 220 which holds the side edge portions 210, namely, the right-side portion and the left-side portion of the door 110.

Each side edge portion 210 of the door 110 extends into the guide cavity 220 a particular distance while leaving a space so that the side edge 280 of the door 110 does not contact the guide cavity wall 290 which is perpendicular to the plane of the door 110, i.e., the deepest point of the guide cavity. In practice, the front and back surfaces of the door 110 will contact the front and back sides (see 230 and 240) of the guide cavity 220 as the door 110 is raised and lowered and in the event that wind and/or pressure differentials cause the door 110 to move forward or backward.

Severe wind forces and pressure differentials, e.g., due to fire conditions, may cause the door 110 to bend or buckle, which tends to pull the side edge portion 210 out of the guide cavity 220. Therefore, the cavity 220 depth and the distance that the side edge portions 210 of the door 110 extend into the cavity 220 must be determined so as to prevent door 110 from being pulled completely out of the cavity 220, which would result in failure of the door to maintain closure. The depth of the cavity 220, i.e., the “guide depth,” depends in part on the total width of the door 110 and may depend on other parameters, such as whether the door is external or internal.

In most applications, the guide depth may be significantly reduced if a “wind lock” 300 is installed on the side edges 280 of the door 110, as shown in FIGS. 2 and 3. The wind lock 300 may be in the form of a metal bracket which is attached to the ends of the horizontal slats. Typically, the wind lock brackets 300 are installed only on every other slat, as opposed to every slat.

The wind lock bracket 300 has a protruding portion 310 which extends outward from the back plane of the door 110. As the side edge portion 210 of the door 100 is pulled out of the guide cavity 220, e.g., by wind forces on the door, this protruding portion 310 of the wind lock 300 will contact, and be stopped by, the stepped portion 270 of the inner guide angle 230 (as noted above, the outer guide angle may also have a stepped portion which acts to prevent the door from being pulled out of the guide cavity in addition to or in lieu of the stepped portion of the inner guide angle). In other words, the protruding portion 310 makes the end of the door 110 too wide to be pulled out of the guide cavity opening 320. The wind lock bracket 300 also helps prevent the horizontal slats 120 from sliding horizontally relative to one another (i.e., by acting as a back stop for the interconnected curled portions of adjacent slats), thereby helping to prevent misalignment of the door edges.

Still referring to FIGS. 2 and 3, a door with a width of, e.g., 18 feet, may require a guide depth of 4 inches to prevent the door from being pulled out of the guide cavity in the event of a severe wind gust or a pressure differential, e.g., due to fire conditions. If a wind lock is used, then a guide depth of only 3 inches may be used. This results in a “shorter” guide, which in turn reduces the total width of the door assembly. It also reduces the width of the door itself, because the door must be sized to cover the door opening plus additional width to accommodate the portions that extend into the guide cavities. Thus, in the present example, the width of the door might be decreased from 18 feet, 8 inches (i.e., for a 4 inch guide depth on each side) to 18 feet, 6 inches (i.e., for a 3 inch guide depth on each side) by using wind locks.

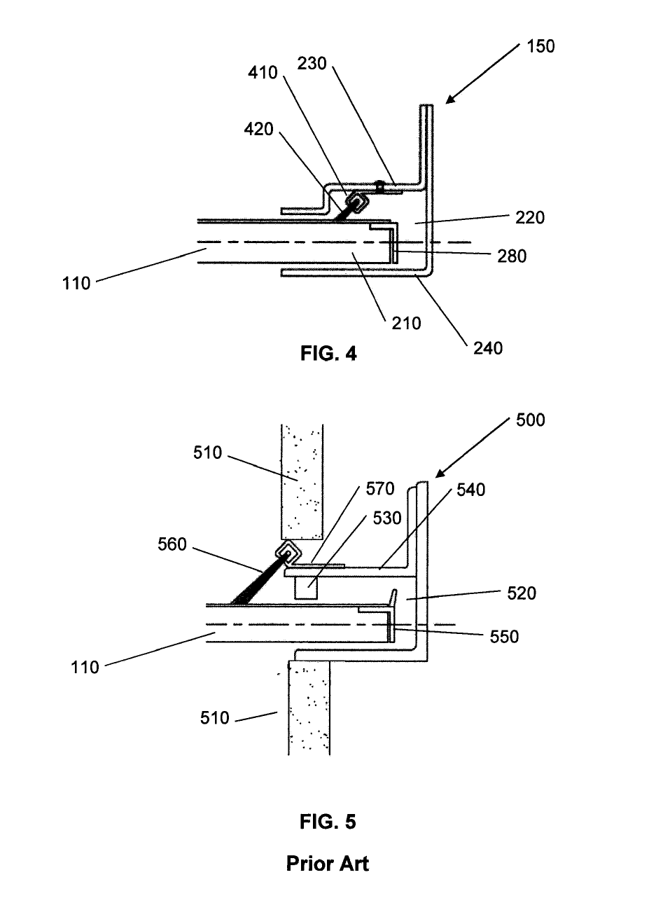

FIG. 4 shows a configuration of the door assembly 100 in which wind lock brackets 300 are not used on the side edges 280 of the door 110. The configuration of the guide member 150 is the same described above with respect to FIGS. 2 and 3.

As further shown in FIG. 4 (see also, FIGS. 2 and 3), a smoke or weather seal 410 may also be provided in the guide cavity 220, such as, for example, a brush 420 which extends along the length of the guide and contacts the back surface of the door 110. The brush 420 thereby prevents drafts of air, and smoke, from passing through the guide cavity 220 and around the side edge 280 of the door. The smoke or weather seal 410 may be installed on the inner guide angle 230 in the wider area of the cavity 220. The bristle end of the brush 420 contacts the back surface of the door 110 to form a seal. This configuration is advantageous over those using a brush which is located outside of the cavity, such as the configuration discussed below in connection with FIG. 5, because the brush is less susceptible to damage and is more aesthetically pleasing due to its internal, i.e., concealed, location. Other materials, such as a strip of elastic material, e.g., rubber, vinyl, or neoprene, may be used as the smoke or weather seal instead of a brush.

Referring again to FIG. 3, as noted above, the inner guide angle 230 of the guide member 150 has a stepped portion 270 at an end thereof. If the door 110 includes wind locks 300 on its side edges 280, this stepped portion 270 acts as a stopper to prevent the ends of the door 110 from being pulled out of the guide cavity 220 in the event of a severe wind gust or pressure differential. The stepped portion 270 also results in a much smaller gap at the guide cavity opening 320. This means that there can be a much smaller gap in the wall 450 in which the guide member 150 is installed, e.g., an interior wall of a corridor or a drywall jamb of a door opening in an external wall of a building. Having a smaller gap in the wall 450 significantly improves the architectural aesthetic qualities of the door assembly in its installed form. In FIG. 3, for example, it can be seen that the gap in the wall 450 is only slightly wider than the door itself. In other words, the gap is as small as possible to accommodate the particular door. The wall gap width can be a significant decision-making factor for an architect selecting a door assembly for a particular application.

FIG. 5 shows a prior art wide-gap vertical guide member 500 having a substantially different configuration and which requires a wider gap in the installation wall 510. The guide cavity 520 in this configuration has a constant width and does not have a stepped-down portion near the opening. A separate stopper bar 530 component is installed in the guide cavity 520 along a surface of the inner guide angle 540 (requiring an additional fabrication step) to prevent the wind lock 550 equipped door from being pulled out of the guide cavity 520. The smoke or weather seal 560 is installed outside of the guide cavity 520 on a surface 570 of the inner guide angle 540 on an opposite side from the stopper bar 530. As can be seen, a substantially wider gap in the installation wall 510 is required to install this vertical guide member 500. Also, the smoke or weather seal 560 is visible, because it is outside the guide cavity 520, and is necessarily longer so that it can reach the surface of the door.

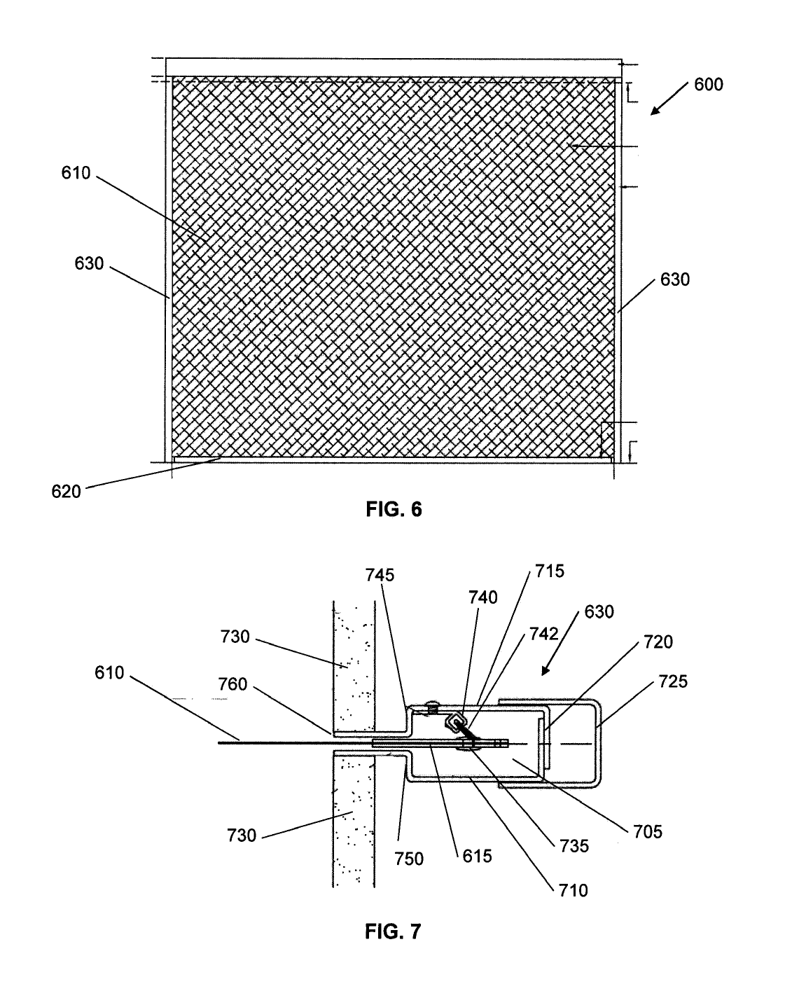

FIG. 6 shows an elevation view of a vertical-coiling fire and smoke rated curtain assembly 600, which includes a planar curtain 610 made of fire resistant material, such as, for example, a woven wire mesh coated with fiberglass and silicone. The curtain 610 also has a rigid bottom bar 620 which is attached to the bottom of the curtain 610 to ensure a good seal where the bottom of the curtain 610 meets the floor. The bottom bar 620 may also help provide a weight force to pull the curtain 610 out of the coiled configuration.

The curtain assembly 600 may be positioned in an opening, such as an opening in an internal wall of a building or an opening spanning a space between two opposed walls which run perpendicular to the plane of the curtain 610, as in a corridor of a building. The curtain assembly 610 includes a pair of vertical guide members 630 positioned on the sides of the door opening, which hold the curtain 610 in place and allow the curtain 610 to move up and down from the coiled configuration

FIG. 7 shows a cross-sectional view of the vertical guide member 630 for the curtain assembly 600. A side edge portion 615 of the curtain fits within a cavity 705 formed by the guide member. The guide member 630 may be formed of rigid members which are made of metal, e.g., steel, stainless steel, aluminum, or other metals.

The guide member 630 may be formed by two side guide members 710, 715 (“side guides”) which form a rectangular cavity. The side guides 710, 715 are joined together at a common portion 720 where faces of the side guides 710, 715 which are perpendicular to the plane of the curtain overlap. For example, the side guides 710, 715 may be bolted or welded together along the common portion 720. This overlapping common portion 720 forms the deepest point of the guide cavity.

A U-shaped adjustment channel 725 may be attached to the faces of the side guides 710, 715 which are parallel to the plane of the curtain 610. The adjustment channel is 725 used to attach the vertical guide member to a wall or support. The point of attachment between the adjustment channel 725 and the side guides 710, 715 can be adjusted to place the side guides 710, 715 at a desired position relative to the gap in the installation wall 730.

A side edge portion 615 of the curtain 610 extends into the guide cavity 705 a particular distance while leaving a space so that the side edge of the curtain does not contact the guide cavity wall (see location indicated by 720) which is perpendicular to the plane of the curtain 610, i.e., the deepest point of the guide cavity. In practice, the front and back surfaces of the curtain 610 will contact the side guides 710, 715 as the curtain 610 is raised and lowered and in the event that wind and/or pressure differentials cause the curtain to move forward or backward.

The side edge portions 615 of the curtain 610 may be provided with reinforcement layers, as depicted in FIG. 7 (see location indicated by 615), to provide rigidity and to provide a secure mounting place for a row of stoppers 735 which are positioned along the side edges to prevent the curtain 610 from being pulled out of the cavity 705. The stoppers 735 may be metal elements, such as fasteners, which extend through the reinforcement layers of the side edge portion 615.

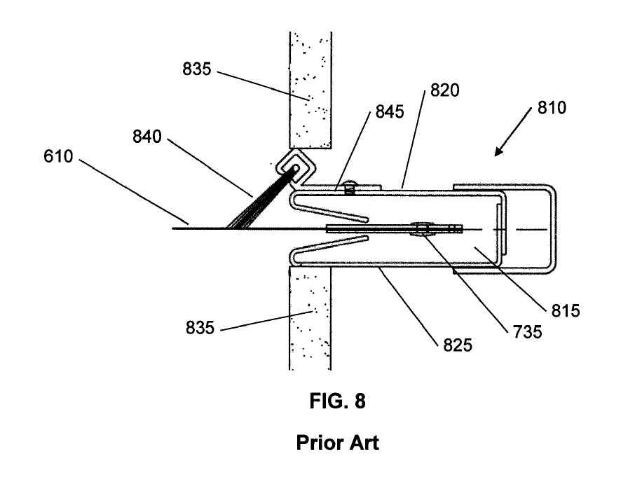

A smoke or weather seal 740 may also be provided in the guide cavity 705, such as, for example, a brush 742 which extends along the length of the guide and contacts the back surface of the curtain. The brush 742 thereby prevents drafts of air, and smoke, from passing through the guide cavity 705 and around the side end of the curtain 610. The smoke or weather seal 740 may be installed on an internal face of one of the side guides (e.g., side guide 715) such that it extends into the cavity. The bristle end of the smoke or weather seal brush 742 contacts the back surface of the curtain 610 to form a seal. This configuration is advantageous over those using a brush which is located outside of the cavity (as discussed below with respect to FIG. 8), because the brush is less susceptible to damage due to its internal, i.e., concealed, location. Also, the aesthetics of the installed curtain assembly are significantly improved, because the brush is not visible.

Each of the side guides 710, 715 has a stepped portion 745, 750 at the opening 760 of the guide cavity 705. These stepped portions 745, 750 act to prevent the ends of the curtain 610 from being pulled out of the guide cavity 705 in the event of a severe wind gust or pressure differential. Specifically, the stepped portions 745, 750 create an opening 760 to the guide cavity 705 which is too narrow for the stoppers 735 on the curtain edge portion 615 to pass through.

The stepped portions 745, 750 also result in a much smaller gap at the opening 760 of the guide cavity 705. This means that there can be a much smaller gap in the installation wall 730 of the guide member, e.g., an interior wall of a corridor or a drywall jamb of a door opening in an interior wall of a building. Having a smaller gap in the installation wall 730 significantly improves the architectural aesthetic qualities of the curtain assembly 600 in its installed form. In FIG. 7, for example, it can be seen that the gap in the installation wall 730 is only slightly wider than the curtain 610 itself. In other words, the gap is as small as possible to accommodate the particular curtain. The wall gap width can be a significant decision-making factor for an architect selecting a door or curtain assembly for a particular application.

FIG. 8 shows a prior art wide-gap vertical guide member 810 having a substantially different configuration and which requires a wider wall gap for installation. The cavity 815 in this configuration has a constant width and does not have a stepped-down portion near the opening. The side guides 820, 825 have angled-in portions at the opening of the cavity 815 to prevent the stoppers 735 on the edge of the curtain 610 from being pulled out of the cavity 815. The smoke or weather seal brush 840 is installed outside of the cavity 815 on an outer surface 845 of the side guide 820. As can be seen, a substantially wider gap in the installation wall 830 is required to install this vertical guide member 810. Also, the smoke or weather seal brush 840 is visible, because it is outside the cavity 815, and is larger so that it can reach the surface of the curtain 610.

The invention is not limited by the embodiments described above which are presented as examples only but can be modified in various ways within the scope of protection defined by the appended patent claims.

What is claimed is:

1. A guide member for a coiling door assembly, the guide member comprising:
a rigid, hollow elongate member having a first wall, a second wall opposing the first wall, and a third wall which is perpendicular to the first and second walls, the first, second, and third walls being arranged to form an internal cavity of the elongate member, the internal cavity having an opening running in a direction of a length of the elongate member along a side of the elongate member opposing the third wall, the internal cavity and opening being configured to receive a side edge portion of the door; and
a seal positioned in the internal cavity and attached to the second wall, the seal being configured to run along the length of the elongate member and to extend into the cavity to contact the side edge portion of the door when the side edge portion of the door is received in the internal cavity,
wherein at least one of the first and second walls has a stepped portion at the opening of the internal cavity which decreases a width of the opening by decreasing a distance between the first and second walls near the opening.

2. The guide member of claim 1, wherein the stepped portion at the opening of the internal cavity decreases a distance between outer surfaces of the first and second walls near the opening of the internal cavity to allow the guide member to be installed in a gap of an installation wall that is narrower than a widest portion of the internal cavity.

3. The guide member of claim 1, wherein the first and third walls are formed by an elongate outer angle member and the second wall is formed by an elongate inner angle member, the outer angle member having a right angle bend between the first and third walls, the inner and outer angle members being affixed together at an overlapping common portion parallel to the third wall.

4. The guide member of claim 3, wherein the common portion provides a mounting portion for affixing the guide member to a wall or support member.

5. The guide member of claim 1, wherein the seal comprises a brush having bristles which extend into the internal cavity.

6. The guide member of claim 1, wherein the seal comprises a strip formed of rubber, vinyl, or neoprene.

7. The guide member of claim 1, wherein the guide member is formed of steel, stainless steel, or aluminum.

8. The guide member of claim 1, wherein the stepped portion acts to prevent wind locks positioned on ends of horizontal slats of a door from passing through the opening of the internal cavity.

9. A coiling door assembly, comprising:
a door formed of pivotally-interlocking horizontal slats;
a lift assembly configured to roll the door up into the coiled position; and
a pair of guide members, each guide member comprising:
a rigid, hollow elongate member having a first wall, a second wall opposing the first wall, and a third wall which is perpendicular to the first and second walls, the first, second, and third walls being arranged to form an internal cavity of the elongate member, the internal cavity having an opening running in a direction of a length of the elongate member along a side of the elongate member opposing the third wall, the internal cavity and opening being configured to receive a side edge portion of the door; and
a seal positioned in the internal cavity and attached to the second wall, the seal being configured to run along the length of the elongate member and to extend into the cavity to contact the side edge portion of the door when the side edge portion of the door is received in the internal cavity,
wherein at least one of the first and second walls has a stepped portion at the opening of the internal cavity which decreases the width of the opening by decreasing a distance between the first and second walls near the opening.

10. The door assembly of claim 9, wherein the stepped portion at the opening of the internal cavity decreases a distance between outer surfaces of the first and second walls near the opening of the internal cavity to allow the guide member to be installed in a gap of an installation wall that is narrower than a widest portion of the internal cavity.

11. The door assembly of claim 9, wherein the first and third walls are formed by an elongate outer angle member and the second wall is formed by an elongate inner angle member, the outer angle member having a right angle bend between the first and third walls, the inner and outer angle members being affixed together at an overlapping common portion parallel to the third wall.

12. The door assembly of claim 9, further comprising a housing which contains the lift assembly and at least a portion of the door, when the door is in a coiled position.

13. The door assembly of claim 9, wherein a plurality of the horizontal slats of the door each comprise a wind lock positioned on at least an end thereof and the stepped portion acts to prevent the wind lock from passing through the opening of the internal cavity.

14. A guide member for a coiling curtain assembly, the guide member comprising:
a rigid, hollow elongate member having a first wall, a second wall opposing the first wall, and a third wall which is perpendicular to the first and second walls, the first, second, and third walls being arranged to form an internal cavity of the elongate member, the internal cavity having an opening running in a direction of a length of the elongate member along a side of the elongate member opposing the third wall, the internal cavity and opening being configured to receive a side edge portion of the curtain; and
a seal positioned in the internal cavity and attached to the second wall, the seal being configured to run along the length of the elongate member and to extend into the cavity to contact the side edge portion of the door when the side edge portion of the curtain is received in the internal cavity,
wherein at least one of the first and second walls has a stepped portion at the opening of the internal cavity which decreases the width of the opening by decreasing a distance between the first and second walls near the opening.

15. The guide member of claim 14, wherein the stepped portion at the opening of the internal cavity decreases a distance between outer surfaces of the first and second walls near the opening of the internal cavity to allow the guide member to be installed in a gap of an installation wall that is narrower than a widest portion of the internal cavity.

16. The guide member of claim 14, wherein the first wall is formed by a first elongate angle member and the second wall is formed by an elongate second angle member, the first angle member having a right angle bend between the first and third walls and the second angle member having a right angle bend between the second and third walls, the inner and outer angle members being affixed together at an overlapping common portion which forms at least a portion of the third wall.

17. The guide member of claim 14, further comprising a U-shaped channel attached to outer faces of the first and second walls

18. The guide member of claim 14, wherein the U-shaped channel provides a mounting portion parallel to the third wall of the guide member for affixing the guide member to a wall or support member

19. The guide member of claim 14, wherein the stepped portion acts to prevent stoppers positioned on side edges of a curtain from passing through the opening of the internal cavity.

20. A coiling curtain assembly, comprising:
a curtain formed of fire resistant material;
a lift assembly configured to roll the curtain up into the coiled position; and
a pair of guide members, each guide member comprising:
a rigid, hollow elongate member having a first wall, a second wall opposing the first wall, and a third wall which is perpendicular to the first and second walls, the first, second, and third walls being arranged to form an internal cavity of the elongate member, the internal cavity having an opening running in a direction of a length of the elongate member along a side of the elongate member opposing the third wall, the internal cavity and opening being configured to receive a side edge portion of the curtain; and
a seal positioned in the internal cavity and attached to the second wall, the seal being configured to run along the length of the elongate member and to extend into the cavity to contact the side edge portion of the door when the side edge portion of the curtain is received in the internal cavity,
wherein at least one of the first and second walls has a stepped portion at the opening of the internal cavity which decreases the width of the opening by decreasing a distance between the first and second walls near the opening.

21. The curtain assembly of claim 20, wherein the stepped portion at the opening of the internal cavity decreases a distance between outer surfaces of the first and second walls near the opening of the internal cavity to allow the guide member to be installed in a gap of an installation wall that is narrower than a widest portion of the internal cavity.

22. The curtain assembly of claim 20, wherein the curtain is formed of woven wire mesh coated with fiberglass.

23. The curtain assembly of claim 20, further comprising a housing which contains the lift assembly and at least a portion of the curtain, when the curtain is in a coiled position.

24. The curtain assembly of claim 20, wherein the curtain comprises a plurality of stoppers positioned along the side edges of the curtain and the stepped portion acts to prevent the stoppers from passing through the opening of the internal cavity.
